(19) United States
(12) Patent Application Publication
(10) Pub. No.: US 2024/0189838 A1
(43) Pub. Date: Jun. 13, 2024

(54) WAND WITH VARIABLE FLOW AND FLOW LOCK

(71) Applicant: Fortune Brands Water Innovations LLC, North Olmsted, OH (US)

(72) Inventors: Christopher John Webber, North Royalton, OH (US); Christopher Douglas Dodd, Lakewood, OH (US)

(21) Appl. No.: 18/532,707

(22) Filed: Dec. 7, 2023

Related U.S. Application Data
(60) Provisional application No. 63/430,866, filed on Dec. 7, 2022.

(51) Int. Cl. B05B 1/12; B05B 1/16; B05B 12/00

(52) U.S. Cl. CPC B05B 1/12; B05B 1/1627; B05B 12/002

(57) ABSTRACT

A wand with variable flow and a flow lock is provided. The wand comprises a shell, a waterway, a flow module, a flow actuator module, and a flow lock module. The waterway includes a first flow passage and a second flow passage. The flow module is operable to be disposed between the first flow passage and the second flow passage. The flow module includes a flow control mechanism that is operable to move between a first position and a second position. The flow actuator module includes a flow actuation mechanism that is operable to move between a first position and a second position. The flow lock module includes a lock mechanism that is operable to move between a first position and a second position. When the lock mechanism is in the first position, the flow control mechanism is operable to move between the first position and the second position. When the lock mechanism is in the second position, the flow control mechanism is not operable to move between the first position and the second position and is locked in the second position. When the lock mechanism is in the second position, the lock mechanism is operable to move from the second position to the first position by at least one of actuating the flow actuation mechanism and actuating the lock mechanism. When the lock mechanism is moved from the second position to the first position, the flow control mechanism is moved from the second position to the first position.

### CROSS-REFERENCE TO RELATED APPLICATION

This application claims the benefit of U.S. Provisional Application No. 63/430,866, filed Dec. 7, 2022, the entire disclosure of which is hereby incorporated by reference.

### FIELD

The present invention relates generally to a wand with variable flow and, more particularly, to a wand with variable flow and a flow lock.

### BACKGROUND

Wands are known. Wands with greater functionality are desired. More specifically, wands with variable flow and the ability to lock the wand in one or more particular flow positions are desired.

### SUMMARY

The present invention provides a wand with variable flow and a flow lock.

In an exemplary embodiment, the wand comprises a shell, a waterway, a flow module, a flow actuator module, and a flow lock module. The shell is operable to pull away from a body of a faucet. The waterway is operable to be substantially disposed in the shell. The waterway includes a first flow passage and a second flow passage. The flow module is operable to be disposed between the first flow passage and the second flow passage. The flow module includes a flow control mechanism. The flow control mechanism is operable to move between a first position and a second position. In the first position, a first volume of water flows from the first flow passage through the flow control mechanism to the second flow passage. In the second position, a second volume of water flows from the first flow passage through the flow control mechanism to the second flow passage. The flow actuator module includes a flow actuation mechanism. The flow actuation mechanism is operable to move between a first position and a second position. As the flow actuation mechanism is moved from the first position to the second position, the flow control mechanism is moved from the first position to the second position. As the flow actuation mechanism is moved from the second position to the first position, the flow control mechanism is moved from the second position to the first position. The flow lock module includes a lock mechanism. The lock mechanism is operable to move between a first position and a second position. When the lock mechanism is in the first position, the flow control mechanism is operable to move between the first position and the second position. When the lock mechanism is in the second position, the flow control mechanism is not operable to move between the first position and the second position and is locked in the second position. When the lock mechanism is in the second position, the lock mechanism is operable to move from the second position to the first position by at least one of actuating the flow actuation mechanism and actuating the lock mechanism. When the lock mechanism is moved from the second position to the first position, the flow control mechanism is operable to move from the second position to the first position.

In an exemplary embodiment, the wand comprises a shell, a waterway, a flow module, a flow actuator module, and a flow lock module. The shell is operable to pull away from a body of a faucet. The waterway is operable to be substantially disposed in the shell. The waterway includes a first flow passage and a second flow passage. The flow module is operable to be disposed between the first flow passage and the second flow passage. The flow module includes a flow control mechanism. The flow control mechanism is operable to move between a first position and a second position. In the first position, a first volume of water flows from the first flow passage through the flow control mechanism to the second flow passage. In the second position, a second volume of water flows from the first flow passage through the flow control mechanism to the second flow passage. The flow actuator module includes a flow actuation mechanism. The flow actuation mechanism is operable to move between a first position and a second position. As the flow actuation mechanism is moved from the first position to the second position, the flow control mechanism is moved from the first position to the second position. As the flow actuation mechanism is moved from the second position to the first position, the flow control mechanism is moved from the second position to the first position. The flow lock module includes a lock mechanism. The lock mechanism is operable to move between a first position and a second position. When the lock mechanism is in the first position, the flow control mechanism is operable to move between the first position and the second position. When the lock mechanism is in the second position, the flow control mechanism is not operable to move between the first position and the second position and is locked in the second position. When the lock mechanism is in the second position, the lock mechanism is operable to move from the second position to the first position by both of actuating the flow actuation mechanism and actuating the lock mechanism. When the lock mechanism is moved from the second position to the first position, the flow control mechanism is operable to move from the second position to the first position.

In an exemplary embodiment, the wand comprises a shell, a waterway, a flow module, a flow actuator module, and a flow lock module. The shell is operable to pull away from a body of a faucet. The waterway is operable to be substantially disposed in the shell. The waterway includes a first flow passage and a second flow passage. The flow module is operable to be disposed between the first flow passage and the second flow passage. The flow module includes a flow control mechanism. The flow control mechanism is operable to move between a first position and a second position. In the first position, a first volume of water flows from the first flow passage through the flow control mechanism to the second flow passage. In the second position, a second volume of water flows from the first flow passage through the flow control mechanism to the second flow passage. As the flow control mechanism is moved from the first position to the second position, a varying volume of water between the first volume of water and the second volume of water flows from the first flow passage through the flow control mechanism to the second flow passage. The flow actuator module includes a flow actuation mechanism. The flow actuation mechanism is operable to move between a first position and a second position. As the flow actuation mechanism is moved from the first position to the second position, the flow control mechanism is moved from the first position to the second position. As the flow actuation mechanism is moved from the second position to the first position, the flow control mechanism is moved from the second position to the first position. The flow lock module includes a lock mechanism. The lock mechanism is operable to move between a first position and a second position. When the lock mechanism is in the first position, the flow control mechanism is operable to move between the first position and the second position. When the lock mechanism is in the second position, the flow control mechanism is not operable to move between the first position and the second position and is locked in the second position. When the lock mechanism is in the second position, the lock mechanism is operable to move from the second position to the first position by at least one of actuating the flow actuation mechanism and actuating the lock mechanism. When the lock mechanism is moved from the second position to the first position, the flow control mechanism is operable to move from the second position to the first position.

### BRIEF DESCRIPTION OF THE DRAWINGS

FIG. 1 is a perspective view of a faucet with a wand according to an exemplary embodiment of the present invention;

FIGS. 2a and 2b are perspective views of the wand of FIG. 1-FIG. 2a shows the wand in a minimum flow position and FIG. 2b shows the wand in a maximum flow position;

FIGS. 3a and 3b are side elevational views of the wand of FIG. 1-FIG. 3a shows the wand in a minimum flow position and FIG. 3b shows the wand in a maximum flow position;

FIGS. 4a and 4b are cross-sectional views of the wand of FIG. 1-FIG. 4a shows the wand in a minimum flow position and FIG. 4b shows the wand in a maximum flow position;

FIGS. 5a and 5b are views of the wand of FIG. 1-FIG. 5a is an exploded perspective view and FIG. 5b is an illustrative view;

FIGS. 6a, 6b, and 6c are partial perspective views of a flow module and flow lock module of the wand of FIG. 1-FIG. 6a shows the wand in an unlocked minimum flow position, FIG. 6b shows the wand in an unlocked maximum flow position, and FIG. 6c shows the wand in a locked maximum flow position; and

FIGS. 7a and 7b are exploded perspective views of components of the flow module and flow lock module of the wand of FIG. 1-FIG. 7a shows one view of the components and FIG. 7b shows an opposing view of the components.

### DETAILED DESCRIPTION

The present invention provides a wand with variable flow and a flow lock. In an exemplary embodiment, the wand is a faucet wand. However, one of ordinary skill in the art will appreciate that the wand could be a side spray, a handheld shower, or any other type of plumbing spray device.

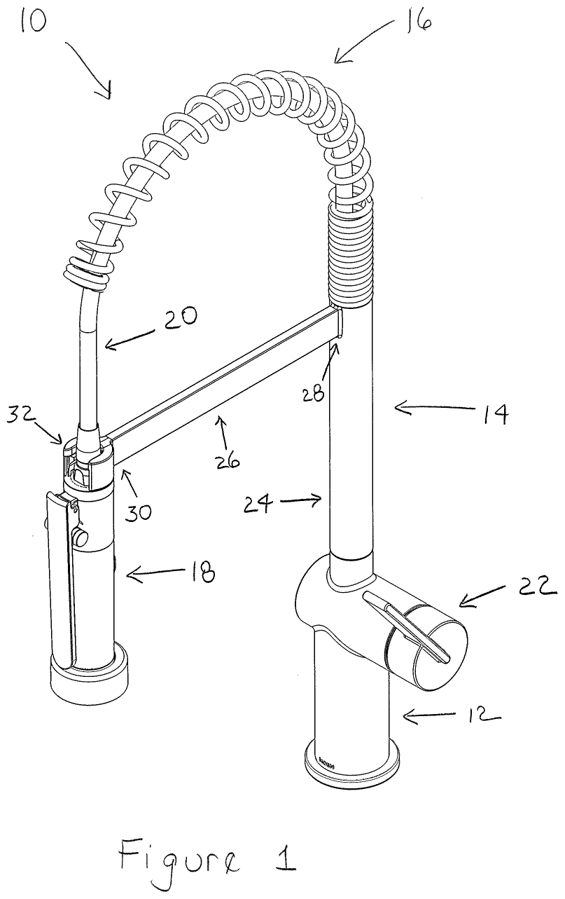

An exemplary embodiment of a faucet 10 of the present invention is shown in detail in FIG. 1. In the illustrated embodiment, the faucet 10 includes a hub 12, an arm 14, a spout 16, a wand 18, a wand hose 20, and a handle 22. A base of the hub 12 is connected (either directly or indirectly) to a mounting surface (such as a counter or sink).

In the illustrated embodiment, the arm 14 includes a vertical portion 24 and a horizontal portion 26. The vertical portion 24 of the arm 14 is connected to the hub 12. In the illustrated embodiment, a bottom of the vertical portion 24 of the arm 14 is connected to a top of the hub 12. The horizontal portion 26 of the arm 14 is connected to the vertical portion 24 of the arm 14. In the illustrated embodiment, a first end 28 of the horizontal portion 26 of the arm 14 is connected to a side of the vertical portion 24 of the arm 14 near a top of the vertical portion 24 of the arm 14. In the illustrated embodiment, a second end 30 of the horizontal portion 26 of the arm 14 includes a hand 32. In the illustrated embodiment, the arm 14 is a swing arm and is operable to rotate relative to the hub 12. In the illustrated embodiment, the arm 14 is generally L-shaped. In the illustrated embodiment, the hand 32 is generally C-shaped.

In the illustrated embodiment, the spout 16 is connected to the arm 14. In the illustrated embodiment, an upstream end of the spout 16 is connected to the top of the vertical portion 24 of the arm 14. In the illustrated embodiment, the spout 16 is operable to rotate relative to the arm 14. In the illustrated embodiment, the spout 16 is a spring spout.

In the illustrated embodiment, the hub 12, the arm 14, and the spout 16 together form a body. However, one of ordinary skill in the art will appreciate that the body does not need to include each of these components. In an exemplary embodiment, the body is operable to be mounted on the mounting surface (such as the counter or sink).

In the illustrated embodiment, the wand 18 is operable to be received in the hand 32 of the arm 14. In the illustrated embodiment, an upstream end of the wand 18 is operable to be received in the hand 32 of the arm 14. The upstream end of the wand 18 is connected to the wand hose 20. In the illustrated embodiment, the wand hose 20 extends through the spout 16, the vertical portion 24 of the arm 14, and the hub 12. The wand 18 is operable to pull away from the body of the faucet 10. In the illustrated embodiment, the wand 18 is operable to pull away from the hand 32 of the arm 14. The wand 18 is operable to deliver water from the faucet 10.

In the illustrated embodiment, the handle 22 is connected to the hub 12. In the illustrated embodiment, the handle 22 is connected to a side of the hub 12. The handle 22 is operable to move relative to the hub 12.

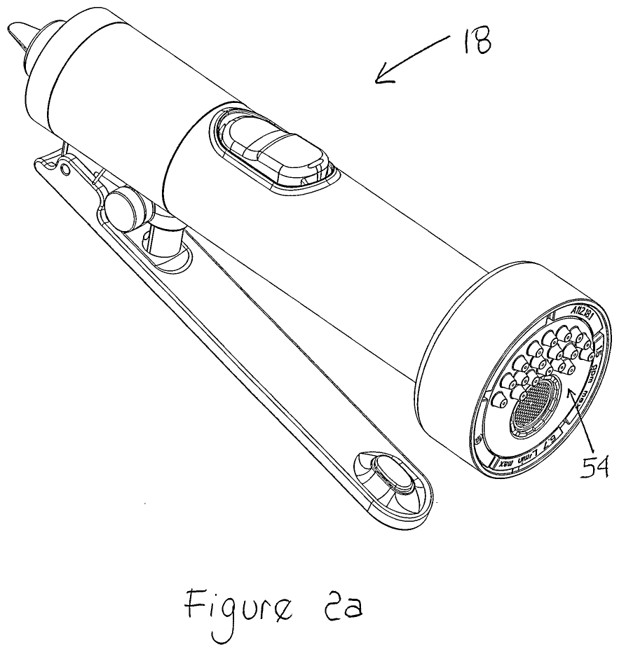

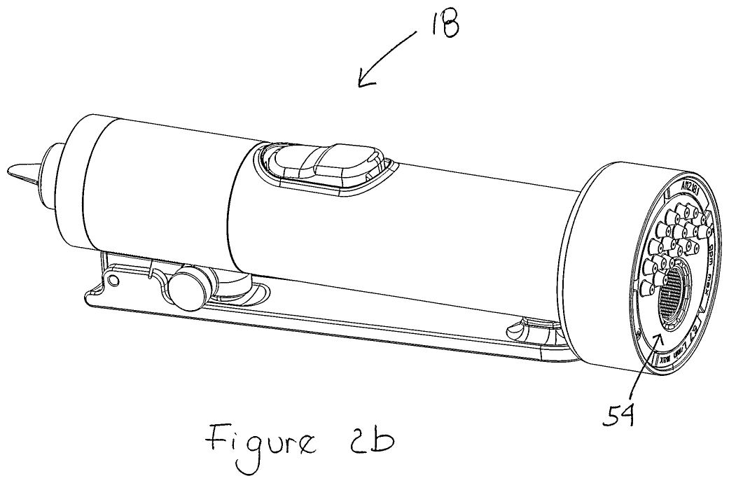

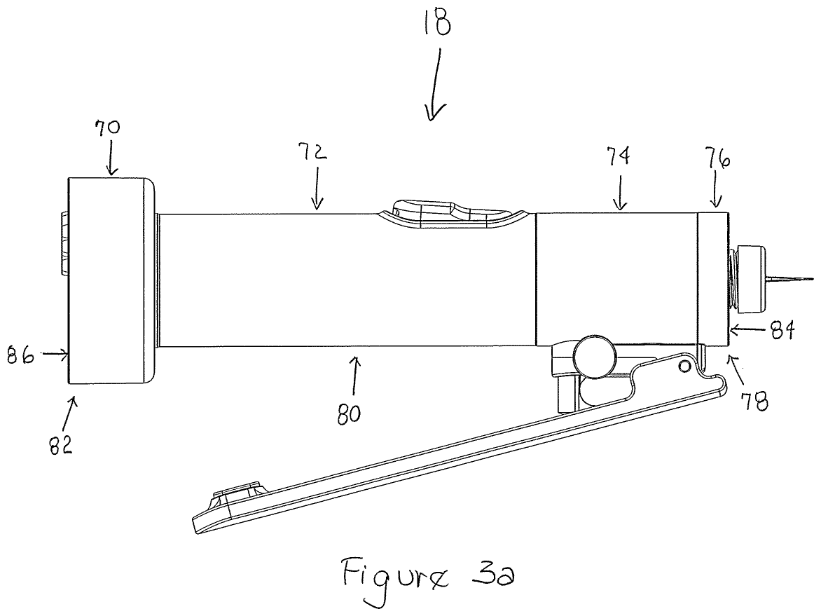

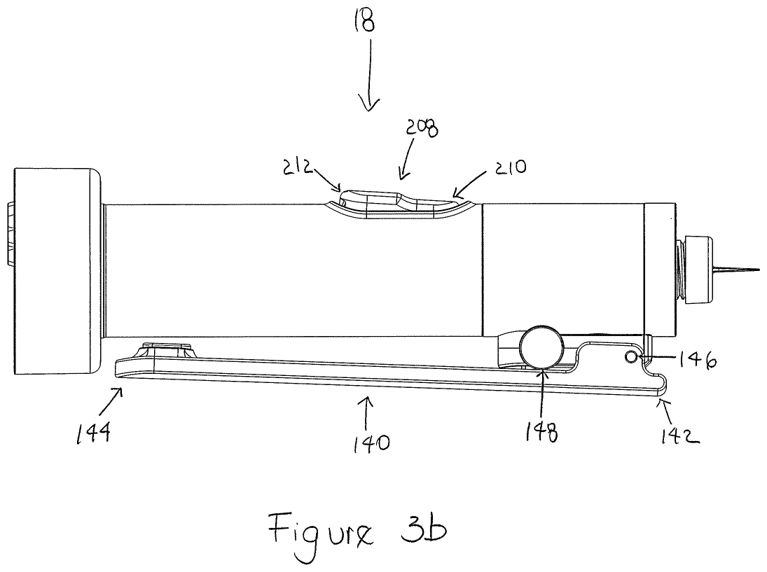

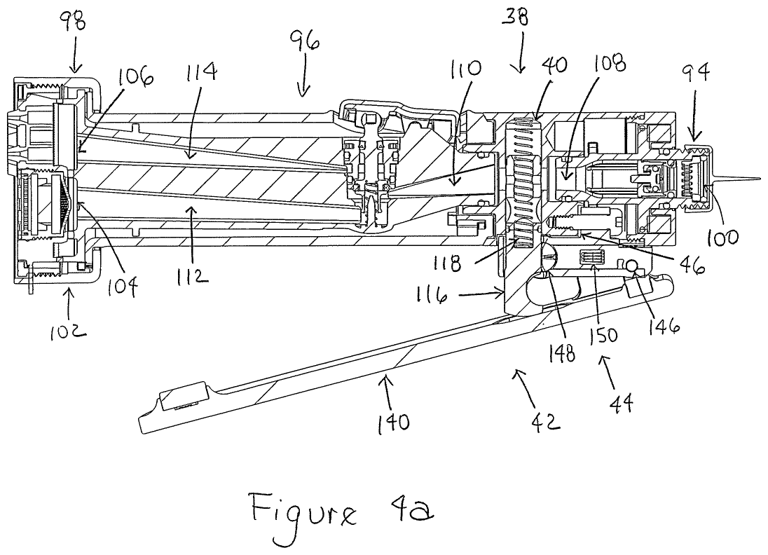

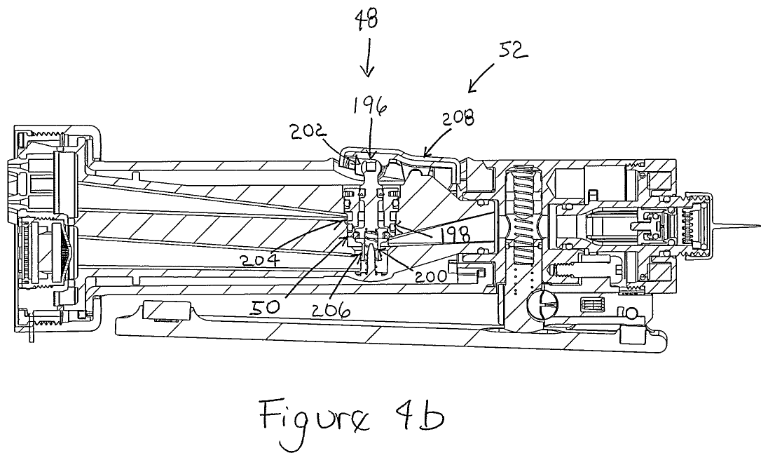

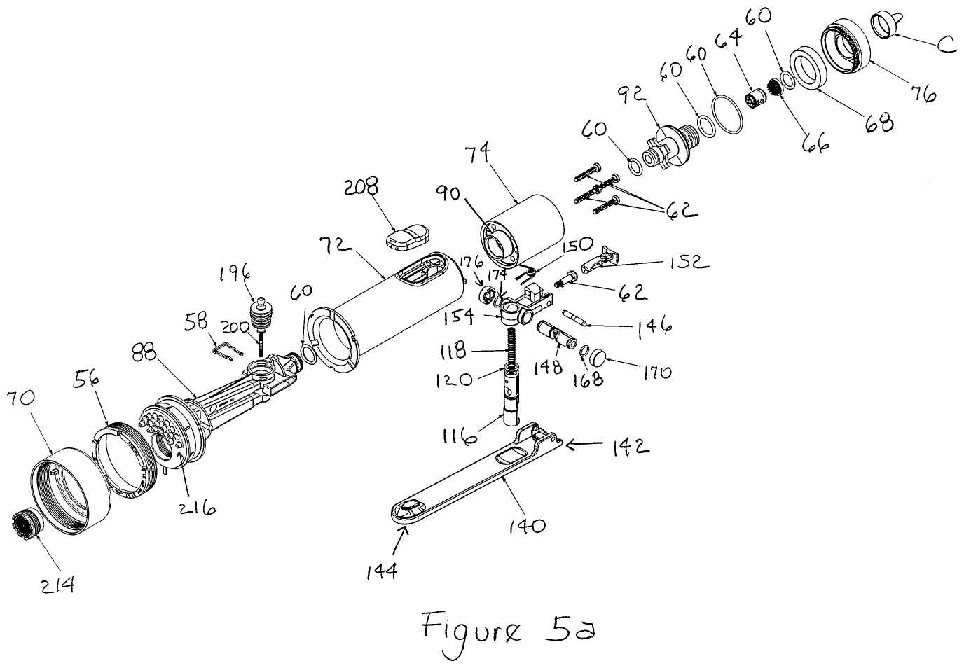

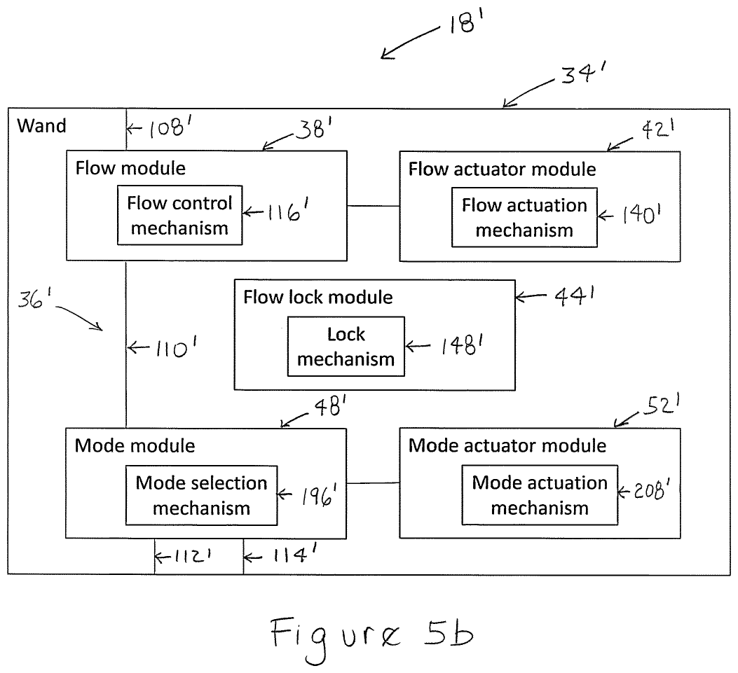

Exemplary embodiments of the wand 18, 18′ are shown in detail in FIGS. 2a-5b. In the illustrated embodiment, the wand 18, 18′ includes a shell 34 and a waterway 36. Additionally, in the illustrated embodiments, the wand 18 includes a flow module 38, 38′, a flow module opening 40, a flow actuator module 42, 42′, a flow lock module 44, 44′, and a flow lock module opening 46. The flow module opening 40 is operable to receive at least a portion of the flow module 38 and/or the flow actuator module 42 extending therethrough. The flow lock module opening 46 is operable to receive at least a portion of the flow lock module 44 extending therethrough. Further, in the illustrated embodiments, the wand 18, 18′ includes a mode module 48, 48′, a mode module opening 50, and a mode actuator module 52, 52′. The mode module opening 50 is operable to receive at least a portion of the mode module 48 and/or the mode actuator module 52 extending therethrough. Moreover, in the illustrated embodiment, the wand 18 includes a face module 54. Furthermore, in the illustrated embodiment, the wand 18 includes a nut 56, a clip 58, O-rings 60, screws 62, a check valve 64, a screen 66, and a ring 68. In the illustrated embodiment, the wand 18 is shown including a cap C. The cap C is for shipping purposes and is removed prior to installation and operation of the wand 18.

In the illustrated embodiment, the flow module 38/flow module opening 40, the flow lock module 44/flow lock module opening 46, and the mode module 48/mode module opening 50 have certain orientations relative to each other and relative to a longitudinal axis of the wand 18. More specifically, the flow module 38/flow module opening 40 and the flow lock module 44/flow lock module opening 46 are upstream of the mode module 48/mode module opening 50. Additionally, the flow module 38/flow module opening 40, the flow lock module 44/flow lock module opening 46, and the mode module 48/mode module opening 50 extend generally transversely to the longitudinal axis of the wand 18. Further, the flow module 38/flow module opening 40 extends generally parallel to the mode module 48/mode module opening 50, and the flow module 38/flow module opening 40 extends generally transversely to the flow lock module 44/flow lock module opening 46.

Exemplary embodiments of the shell 34, 34′ are shown in detail in FIGS. 2a-5b. The shell 34 is operable to pull away from the body of the faucet 10. In the illustrated embodiment, the shell 34 is operable to pull away from the hand 32 of the arm 14. In the illustrated embodiment, the shell 34 includes a front ring 70, a front body 72, a rear body 74, and a rear ring 76. In the illustrated embodiment, the shell 34 includes an upstream end 78, a mid-section 80, and a downstream end 82. In the illustrated embodiment, the shell 34 includes a generally cylindrical portion extending from the upstream end 78 to the downstream end 82. In an exemplary embodiment, the shell 34 includes an upstream opening 84 in the upstream end 78 and a downstream opening 86 in the downstream end 82.

Exemplary embodiments of the waterway 36, 36′ are shown in detail in FIGS. 2a-5b. In the illustrated embodiment, portions of the waterway 36 are separately formed from the shell 34 and portions of the waterway 36 are unitarily formed with the shell 34. The waterway 36 is operable to be substantially disposed in the shell 34. In the illustrated embodiment, the waterway 36 includes a front engine 88, a rear engine 90, and an adapter 92. In the illustrated embodiment, the waterway 36 includes an upstream end 94, a mid-section 96, and a downstream end 98. In the illustrated embodiment, the waterway 36 includes an inlet 100 in the upstream end 94 and an outlet 102 in the downstream end 98. In the illustrated embodiment, the waterway 36 includes a first or stream outlet 104 and a second or spray outlet 106 in the downstream end 98.

In the illustrated embodiments, the waterway 36, 36′ includes a first flow passage 108, 108′ and a second flow passage 110, 110′. In the illustrated embodiments, the waterway 36, 36′ includes a third flow passage 112, 112′ and a fourth flow passage 114, 114′. In the illustrated embodiment, the waterway 36 includes the first or upstream flow passage 108 extending from the upstream end 94 into the mid-section 96 (and, more particularly, from the inlet 100 to the flow module opening 40), the second or middle flow passage 110 extending in the mid-section 96 (and, more particularly, from the flow module opening 40 to the mode module opening 50), the third or downstream stream flow passage 112 extending from the mid-section 96 into the downstream end 98 (and, more particularly, from the mode module opening 50 to the first or stream outlet 104), and the fourth or downstream spray flow passage 114 extending from the mid-section 96 into the downstream end 98 (and, more particularly, from the mode module opening 50 to the second or spray outlet 106).

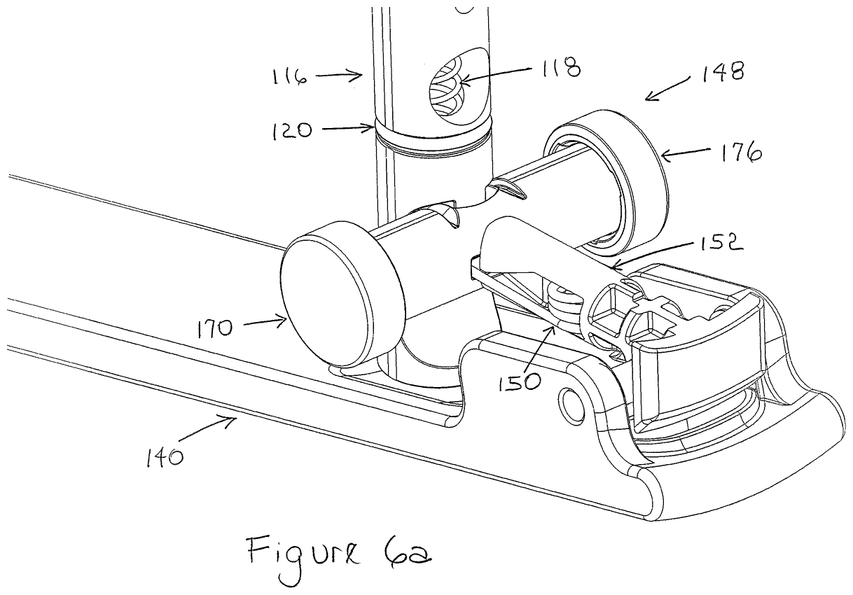

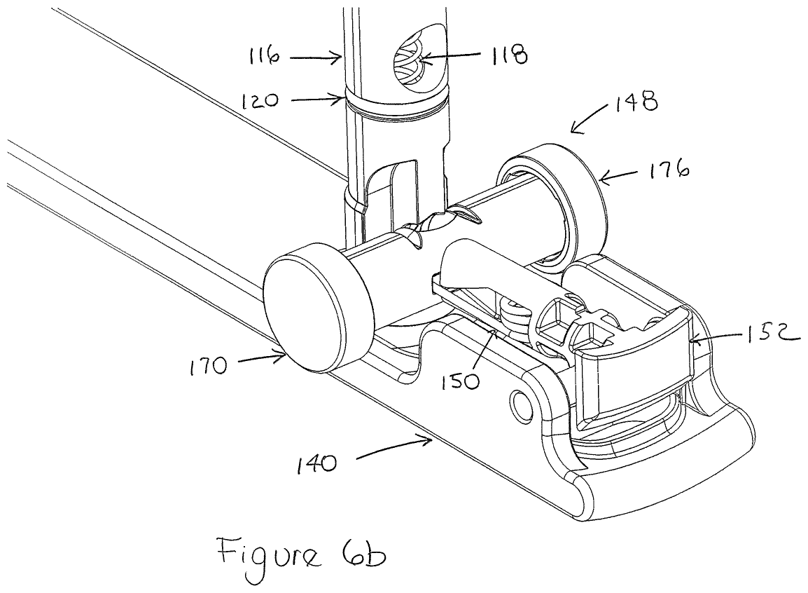

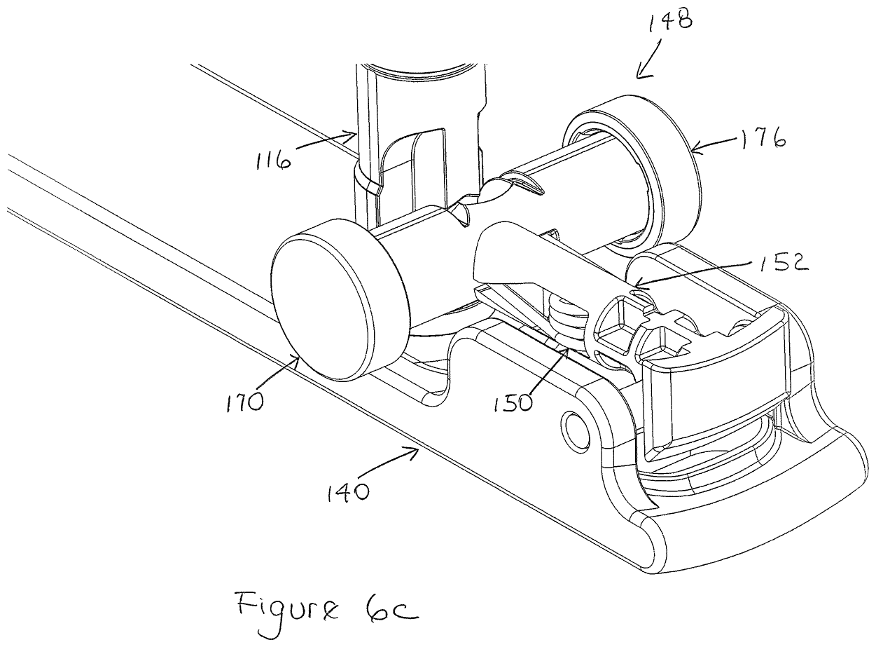

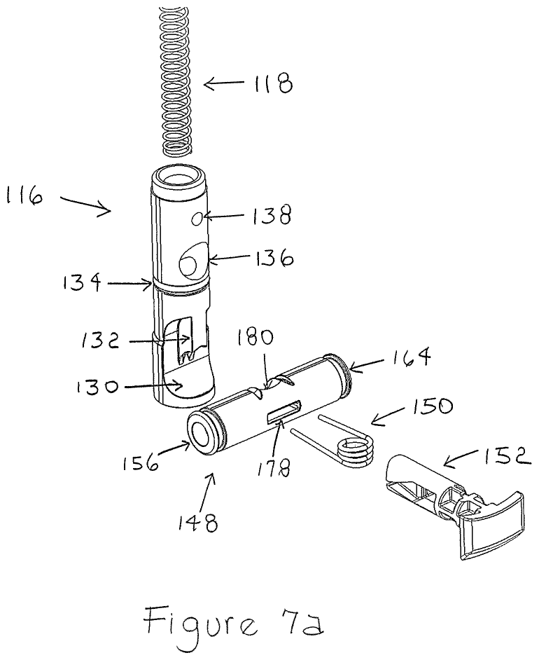

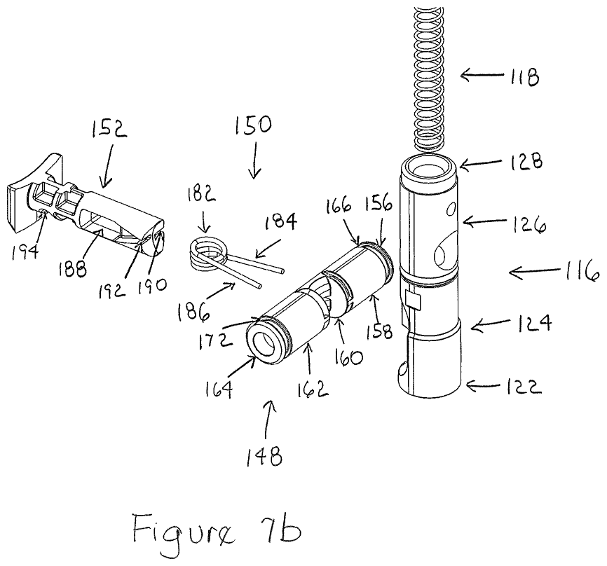

Exemplary embodiments of the flow module 38, 38′ are shown in detail in FIGS. 2a-7b. The flow module 38′ is operable to be disposed between the first flow passage 108′ and the second flow passage 110′. In the illustrated embodiment, the flow module 38′ includes a flow control mechanism 116′. In an exemplary embodiment, the flow control mechanism 116′ is operable to move between a first position and a second position. In the first position, a first volume of water flows from the first flow passage 108′ through the flow control mechanism 116′ to the second flow passage 110′. In the second position, a second volume of water flows from the first flow passage 108′ through the flow control mechanism 116′ to the second flow passage 110′. In an exemplary embodiment, the first volume of water is less than the second volume of water. In an exemplary embodiment, the first volume of water is a minimum volume of water, and the second volume of water is a maximum volume of water.

In the illustrated embodiment, the flow module 38 is operable to be disposed between the first flow passage 108 and the second flow passage 110. In the illustrated embodiment, the flow module 38 includes a flow piston 116. Additionally, in the illustrated embodiment, the flow module 38 includes a flow spring 118 and a flow seal 120. In the illustrated embodiment, the flow piston 116 is operable to move in the flow module opening 40 in the wand 18 between a first or outward position and a second or inward position. In the illustrated embodiment, the flow piston 116 includes a first or outer end portion 122, a first cylindrical portion 124, a second cylindrical portion 126, and a second or inner end portion 128. In the illustrated embodiment, the first cylindrical portion 124 is generally solid, and the second cylindrical portion 126 is generally hollow. In the illustrated embodiment, the first cylindrical portion 124 includes a lock pin groove 130 and a lock pin key 132. In the illustrated embodiment, the second cylindrical portion 126 includes a flow seal groove 134, a large flow opening 136, and a small flow opening 138. The flow seal groove 134 is operable to receive the flow seal 120. Exemplary flow seals include O-rings, cup seals, and lip seals. In the illustrated embodiment, the large flow opening 136 extends transversely through the second cylindrical portion 126, and the small flow opening 138 extends transversely through the second cylindrical portion 126. In the illustrated embodiment, the large flow opening 136 is outward of the small flow opening 138. The second cylindrical portion 126 is operable to receive the flow spring 118 longitudinally therein. In the illustrated embodiment, the flow spring 118 is a coil spring. In the illustrated embodiment, a diameter of the first cylindrical portion 124 is approximately the same as a diameter of the second cylindrical portion 126.

In the illustrated embodiment, in the first or outward position of the flow piston 116, water flows from the first or upstream flow passage 108 through the small flow opening 138 in the second cylindrical portion 126 of the flow piston 116 to the second or middle flow passage 110. In the illustrated embodiment, in the second or inward position of the flow piston 116, water flows from the first or upstream flow passage 108 through the large flow opening 136 in the second cylindrical portion 126 of the flow piston 116 to the second or middle flow passage 110. In the illustrated embodiment, since a flow area through the small flow opening 138 is less than a flow area through the large flow opening 136, a lower volume of water flows through the wand 18 when the flow piston 116 is in the first or outward position than when the flow piston 116 is in the second or inward position. Between the first or outward position and the second or inward position of the flow piston 116, water flows from the first or upstream flow passage 108 through the small flow opening 138 and/or a varying length of the large flow opening 136 to the second or middle flow passage 110. Initially, water flows through both the small flow opening 138 and a portion of the large flow opening 136. Then, water flows through only an increasing portion of the large flow opening 136. Thus, as the flow piston 116 is moved between the first or outward position and the second or inward position, a varying (and, more particularly, an increasing) volume of water flows through the flow piston 116.

Exemplary embodiments of the flow actuator module 42, 42′ are shown in detail in FIGS. 2a-7b. In the illustrated embodiment, the flow actuator module 42′ includes a flow actuation mechanism 140′. The flow actuation mechanism 140′ is operable to move between a first position and a second position. As the flow actuation mechanism 140′ is moved from the first position to the second position, the flow control mechanism 116′ is moved from the first position to the second position. As the flow actuation mechanism 140′ is moved from the second position to the first position, the flow control mechanism 116′ is moved from the second position to the first position.

In the illustrated embodiment, the flow actuator module 42 includes a flow lever 140. The flow lever 140 includes a first or connected end 142 and a second or free end 144. In the illustrated embodiment, the first or connected end 142 is operable to be connected to the shell 34 near the upstream end 78 of the shell 34. More particularly, the first or connected end 142 is operable to be connected to the shell 34 upstream of the flow module opening 40 in the wand 18. In the illustrated embodiment, the flow lever 140 is connected to the shell 34 via a flow lever pin 146. In the illustrated embodiment, the second or free end 144 is operable to move toward and away from the shell 34. As the second or free end 144 of the flow lever 140 is moved toward the shell 34 from the first or outward position to the second or inward position, the flow piston 116 is moved from the first or outward position to the second or inward position. As the second or free end 144 of the flow lever 140 is moved away from the shell 34 from the second or inward position to the first or outward position, the flow piston 116 is moved from the second or inward position to the first or outward position.

Exemplary embodiments of the flow lock module 44, 44′ are shown in detail in FIGS. 2a-7b. In the illustrated embodiment, the flow lock module 44′ includes a lock mechanism 148′. The lock mechanism 148′ is operable to move between a first position and a second position. When the lock mechanism 148′ is in the first position, the flow control mechanism 116′ is operable to move between the first position and the second position. When the lock mechanism 148′ is in the second position, the flow control mechanism 116′ is not operable to move between the first position and the second position and is locked in the second position. Thus, when the flow control mechanism 116′ is locked in the second position, the flow control mechanism 116′ is not operable to vary the volume of water flowing through the wand 18′. When the lock mechanism 148′ is moved from the second position to the first position, the flow control mechanism 116′ is operable to move from the second position to the first position. In an exemplary embodiment, when the lock mechanism 148′ is in the second position, the lock mechanism 148′ is operable to move from the second position to the first position by at least one of actuating the flow actuation mechanism 140′ and actuating the lock mechanism 148′. In an exemplary embodiment, when the lock mechanism 148′ is in the second position, the lock mechanism 148′ is operable to move from the second position to the first position by both of actuating the flow actuation mechanism 140′ and actuating the lock mechanism 148′.

In the illustrated embodiment, the flow lock module 44 includes a lock pin 148. In the illustrated embodiment, the lock pin 148 is operable to move in the lock pin groove 130 in the first cylindrical portion 124 of the flow piston 116 between a first or center position and a second or off-center position. In the illustrated embodiment, the lock pin 148 includes a first end portion 156, a first side portion 158, a central portion 160, a second side portion 162, and a second end portion 164. Additionally, in the illustrated embodiment, the first end portion 156 of the lock pin 148 includes a first lock seal groove 166 operable to receive a first lock seal 168 and is covered by a first lock cap 170, and the second end portion 164 of the lock pin 148 includes a second lock seal groove 172 operable to receive a second lock seal 174 and is covered by a second lock cap 176. In the illustrated embodiment, the first side portion 158 and the second side portion 162 of the lock pin 148 are generally cylindrical shaped. In the illustrated embodiment, the central portion 160 of the lock pin 148 includes a lock spring opening 178 and a flow piston groove 180. In the illustrated embodiment, the lock spring opening 178 and the flow piston groove 180 are diametrically opposed to each other.

Additionally, in the illustrated embodiment, the flow lock module 44 includes a lock spring 150, a lock spring holder 152, and a lock housing 154. In the illustrated embodiment, the lock spring 150 includes a coiled portion 182, a first leg 184, and a second leg 186. In the illustrated embodiment, the lock spring 150 is a torsion spring. In the illustrated embodiment, the lock spring holder 152 includes an opening 188, a first channel 190, a second channel 192, and a lever pin groove 194. The opening 188 of the lock spring holder 152 is operable to receive the coiled portion 182 of the lock spring 150. The first channel 190 in the lock spring holder 152 is operable to receive the first leg 184 of the lock spring 150, and the second channel 192 in the lock spring holder 152 is operable to receive the second leg 186 of the lock spring 150. The lever pin groove 194 in the lock spring holder 152 is operable to receive the flow lever pin 146. In the illustrated embodiment, the lock spring opening 178 in the central portion 160 of the lock pin 148 is operable to receive an end of the first leg 184 and an end of the second leg 186 of the lock spring 150. In the illustrated embodiment, the flow piston groove 180 in the central portion 160 of the lock pin 148 is operable to receive the flow piston 116 (and, more particularly, the lock pin key 132 of the first cylindrical portion 124 of the flow piston 116). The lock housing 154 is operable to receive at least a portion of components of the flow module 38 and the flow lock module 44. In the illustrated embodiment, the lock housing 154 is operable to receive at least a portion of the flow piston 116, the lock pin 148, the lock spring 150, the lock spring holder 152, and the flow lever pin 146.

In the illustrated embodiment, in the first or center position of the lock pin 148, the flow piston 116 is operable to move relative to the lock pin 148 between the first or outward position and the second or inward position. More particularly, the lock pin key 132 of the first cylindrical portion 124 of the flow piston 116 is operable to move in the flow piston groove 180 in the central portion 160 of the lock pin 148 between the first or outward position and the second or inward position. Thus, the flow piston 116 is operable to vary the volume of water flowing through the wand 18 from a minimum volume of water to a maximum volume of water.

In the illustrated embodiment, when the flow piston 116 is moved to the second or inward position, the lock pin 148 is operable to move relative to the flow piston 116 between the first or center position and the second or off-center position. More particularly, the lock pin 148 is operable to move in the lock pin groove 130 in the first cylindrical portion 124 of the flow piston 116 and, thus, into the second or off-center position. In the second or off-center position of the lock pin 148, the flow piston 116 (and, more particularly, the lock pin key 132 of the first cylindrical portion 124 of the flow piston 116) is not operable to move in the flow piston groove 180 in the central portion 160 of the lock pin 148 and is locked in the second or inward position. Thus, the flow piston 116 is not operable to vary the volume of water flowing through the wand 18 and a maximum volume of water is flowing through the wand 18.

Operation of exemplary embodiments of the flow module 38, 38′, the flow actuator module 42, 42′, and the flow lock module 44, 44′ (as shown in detail in FIGS. 2a-7b) will be described. The flow spring 118 exerts a flow spring force, which is a mechanical force. The flow spring force biases the flow piston 116 to the first or outward position. Water flowing through the flow piston 116 in the flow module opening 40 exerts a flow water pressure force, which is a hydraulic force. The net flow water pressure force also biases the flow piston 116 to the first or outward position. When the flow piston 116 is in the first or outward position and water is flowing through the flow piston 116 in the flow module opening 40, the water flows from the first or upstream flow passage 108 through the small flow opening 138 in the second cylindrical portion 126 of the flow piston 116 to the second or middle flow passage 110.

When a user presses the second or free end of the flow lever 140 (or actuates another flow actuation mechanism 140′), the spring force and the net flow water pressure force are overcome, and the flow piston 116 moves toward the second or inward position. When the flow piston 116 is in the second or inward position and water is flowing through the flow piston 116 in the flow module opening 40, the water flows from the first or upstream flow passage 108 through the large flow opening 136 in the second cylindrical portion 126 of the flow piston 116 to the second or middle flow passage 110. While the user has the second or free end of the flow lever 140 pressed (or another flow actuation mechanism 140′ actuated) and the flow spring force and the net flow water pressure force are overcome, the user can press the first end portion 156 of the lock pin 148 (or actuate another lock mechanism 148′) and move the lock pin 148 from the first or center position to the second or off-center position. The lock spring 150 exerts a net lock spring force, which is a mechanical force. The net lock spring force biases the lock pin 148 to the first or center position. When the lock pin 148 is in the first or center position, the flow piston 116 is operable to move in the flow piston groove 180 in the central portion 160 of the lock pin 148. When the lock pin 148 is in the second or off-center position and water is flowing through the flow module opening 40, the contact between the lock pin 148 and the lock pin groove 130 in the first cylindrical portion 124 of the flow piston 116 creates a friction force, which is a mechanical force. The friction force maintains the lock pin 148 in the second or off-center position and, thus, the flow piston 116 in the second or inward position.

As long as water is flowing through the flow piston 116 in the flow module opening 40, the friction force overcomes the net lock spring force, the flow spring force, and the net flow water pressure force and maintains the lock pin 148 in the second or off-center position and, thus, the flow piston 116 in the second or inward position. When water stops flowing through the flow piston 116 in the flow module opening 40, the net lock spring force overcomes the friction force and moves the lock pin 148 to the first or center position. Then, the flow spring force and any residual net flow water pressure force move the flow piston 116 to the first or outward position. Water could stop flowing through the flow piston 116 as a result of a user moving the handle 22 to a closed position to stop the flow of water through the faucet 10 or actuating a pause button on the wand 18 (not shown) to pause the flow of water through the faucet 10.

Alternatively, even if water is flowing through the flow piston 116 in the flow module opening 40, when a user presses the second or free end of the flow lever 140 (or actuates another flow actuation mechanism 140′), the net lock spring force overcomes the reduced friction force and moves the lock pin 148 to the first or center position. Then, when the user releases the second or free end of the flow lever 140 (or releases another flow actuation mechanism 140′), the flow spring force and the net water pressure force move the flow piston 116 to the first or outward position.

Further alternatively, even if water is flowing through the flow module opening 40, when a user presses the second end portion 164 of the lock pin 148 (or actuates another lock mechanism 148′), the actuation force and the net lock spring force overcome the friction force and move the lock pin 148 to the first or center position. Then, the flow spring force and the net flow water pressure force move the flow piston 116 to the first or outward position.

Exemplary embodiments of the mode module 48, 48′ are shown in detail in FIGS. 2a-5b. The mode module 48′ is operable to be disposed between the second flow passage 110′ and the third flow passage 112′ and the fourth flow passage 114′. In the illustrated embodiment, the mode module 48′ includes a mode selection mechanism 196′. The mode selection mechanism 196′ is operable to move between a first position and a second position. In the first position, water flows from the second flow passage 110′ to the third flow passage 112′. In the second position, water flows from the second flow passage 110′ to the fourth flow passage 114′. In an exemplary embodiment, water flowing through the third flow passage 112′ is delivered from the wand 18′ in the form of a stream, and water flowing through the fourth flow passage 114′ is delivered from the wand 18′ in the form of a spray.

In the illustrated embodiment, the mode module 48 is operable to be disposed between the second flow passage 110 and the third flow passage 112 and the fourth flow passage 114. In the illustrated embodiment, the mode module 48 includes a mode piston 196. Additionally, in the illustrated embodiment, the mode module 48 includes a mode seat 198 and a mode spring 200. In the illustrated embodiment, the mode piston 196 is operable to move in the mode module opening 50 in the wand 18 between a first or outward position and a second or inward position. In the illustrated embodiment, the mode piston 196 includes a first or outer portion 202, a middle portion 204, and a second or inner portion 206. In the illustrated embodiment, the mode seat 198 is operable to be located in a stationary position in the mode module opening 50 in the wand 18. In the illustrated embodiment, the mode spring 200 is operable to interface with the second or inner portion 206 of the mode piston 196. In the illustrated embodiment, the mode spring 200 is a coil spring. In the illustrated embodiment, in the first or outward position of the mode piston 196, water flows from the second or middle flow passage 110 to the third or downstream stream flow passage 112 and is delivered from the wand 18 in the form of a stream. In the illustrated embodiment, in the second or inward position of the mode piston 196, water flows from the second or middle flow passage 110 to the fourth or downstream spray flow passage 114 and is delivered from the wand 18 in the form of a spray. In an exemplary embodiment, a default position of the mode piston 196 is the first or outward position, and an actuated position of the mode piston 196 is the second or inward position. As a result, a default mode of the wand 18 is a stream mode, and an actuated mode of the wand 18 is a spray mode.

Exemplary embodiments of the mode actuator module 52, 52′ are shown in detail in FIGS. 2a-5b. In an exemplary embodiment, the mode actuator module 52′ includes a mode actuation mechanism 208′. The mode actuation mechanism 208′ is operable to move between a first position and a second position. As the mode actuation mechanism 208′ is moved from the first position to the second position, the mode selection mechanism 196′ is moved from the first position to the second position. As the mode actuation mechanism 208′ is moved from the second position to the first position, the mode selection mechanism 196′ is moved from the second position to the first position.

In the illustrated embodiment, the mode actuator module 52 includes a mode toggle button 208. In the illustrated embodiment, the mode toggle button 208 is oblong shaped. The mode toggle button 208 includes an upstream portion 210 and a downstream portion 212. In the illustrated embodiment, the downstream portion 212 of the mode toggle button 208 is operable to connect to the first or outer portion 202 of the mode piston 196. In the illustrated embodiment, when the downstream portion 212 of the mode toggle button 208 is pressed, the mode piston 196 is moved from the first or outward default position to the second or inward actuated position. In the illustrated embodiment, when the upstream portion 210 of the mode toggle button 208 is pressed, the mode piston 196 is moved from the second or inward actuated position to the first or outward default position.

Operation of an exemplary embodiment of the mode module 48 and the mode actuator module 52 (as shown in detail in FIGS. 2a-5b) will be described. The mode spring 200 exerts a mode spring force, which is a mechanical force. The mode spring force biases the mode piston 196 to the first or outward position. Water flowing through the mode piston 196 in the mode module opening 50 exerts a mode water pressure force, which is a hydraulic force. The position to which the mode water pressure force biases the mode piston 196 depends on the position of the mode piston 196. When the mode piston 196 is in the first or outward position and water is flowing through the mode piston 196 in the mode module opening 50, the mode water pressure force also biases the mode piston 196 to the first or outward position and water flows from the middle flow passage around the second or inner portion 206 of the mode piston 196 to the third or downstream stream flow passage 112.

When a user presses the downstream portion 212 of the mode toggle button 208 (or actuates another mode actuation mechanism 208′), the spring force is overcome, and the mode piston 196 moves to the second or inward position. When the mode piston 196 is in the second or inward position and water is flowing through the mode piston 196 in the mode module opening 50, the mode water pressure force biases the mode piston 196 to the second or inward position and water flows from the middle flow passage around the middle portion 204 of the mode piston 196 to the fourth or downstream spray flow passage 114.

As long as water is flowing through the mode piston 196 in the mode module opening 50, the mode water pressure force overcomes the spring force and maintains the mode piston 196 in the second or inward position. When water stops flowing through the mode piston 196 in the mode module opening 50, the spring force overcomes the mode water pressure force, and the mode piston 196 moves to the first or outward position.

Alternatively, even if water is flowing through the mode piston 196 in the mode module opening 50, when a user presses the upstream portion 210 of the mode toggle button 208 (or actuates another mode actuation mechanism 208′), the mode water pressure force is overcome, and the mode piston 196 moves to the first or outward position.

An exemplary embodiment of the face module 54 is shown in detail in FIGS. 2a-5b. In the illustrated embodiment, the face module 54 is connected to the downstream end 82 of the shell 34 and/or the downstream end 98 of the waterway 36. In the illustrated embodiment, the face module 54 includes an aerator 214 and a plurality of wand nozzles 216. In the illustrated embodiment, the aerator 214 and the wand nozzles 216 are both offset from a center of the face module 54. The aerator 214 fluidly communicates with the third or downstream stream flow passage 112 and delivers water from the wand 18 in the form of a stream. The wand nozzles 216 fluidly communicate with the fourth or downstream spray flow passage 114 and deliver water from the wand 18 in the form of a spray.

While the faucet 10 and the wand 18 have been shown and described in the illustrated embodiment as including certain components, one of ordinary skill in the art will appreciate that the faucet 10 and the wand 18 do not need to include each of these components and/or the specifics of each of these components.

While the faucet 10 and the wand 18 have been shown and described in the illustrated embodiment with the components connected in a particular manner, one of ordinary skill in the art will appreciate that the components of the faucet 10 and the wand 18 do not need to be connected in this particular manner.

While the faucet 10 and the wand 18 have been shown and described in the illustrated embodiment with the components assembled in a particular order, one of ordinary skill in the art will appreciate that the components of the faucet 10 and the wand 18 do not need to be assembled in this particular order.

For example, the faucet 10 has been shown and described as including an arm 14 (which includes a hand 32) and a spring spout 16. However, one of ordinary skill in the art will appreciate that the faucet 10 may not include an arm 14 (or a hand 32) and/or the faucet 10 may include a non-spring spout. Similarly, the arm 14 (including the hand 32) and the spout 16 have been shown and described as being operable to rotate. However, one of ordinary skill in the art will appreciate that the arm 14 (including the hand 32) and/or the spout 16 may be fixed.

Additionally, the wand 18 has been shown and described as having two modes—a stream mode and a spray mode. However, one of ordinary skill in the art will appreciate that the wand 18 could have more or less modes and/or different modes.

Further, the wand 18 has been shown and described with the flow module 38/flow module opening 40, the flow lock module 44/flow lock module opening 46, and the mode module 48/mode module opening 50 having certain orientations relative to each other and relative to the longitudinal axis of the wand 18. However, one of ordinary skill in the art will appreciate that the wand 18 could have these modules/openings in other orientations relative to each other and relative to the longitudinal axis of the wand 18.

More specifically, the wand 18 has been shown and described as having the flow module 38/flow module opening 40 and the flow lock module 44/flow lock module opening 46 upstream of the mode module 48/mode module opening 50. However, one of ordinary skill in the art will appreciate that the wand 18 could have the flow module 38/flow module opening 40 and the flow lock module 44/flow lock module opening 46 downstream of the mode module 48/mode module opening 50.

Additionally, the wand 18 has been shown and described as having the flow module 38/flow module opening 40, the flow lock module 44/flow lock module opening 46, and the mode module 48/mode module opening 50 extending generally transversely to the longitudinal axis of the wand 18. However, one of ordinary skill in the art will appreciate that the wand 18 could have one or more of these modules/openings extending in other orientations relative to the longitudinal axis of the wand 18 (e.g., parallel).

Further, the wand 18 has been shown and described as having the flow module 38/flow module opening 40 extending generally parallel to the mode module 48/mode module opening 50, and the flow module 38/flow module opening 40 extending generally transversely to the flow lock module 44/flow lock module opening 46. However, one of ordinary skill in the art will appreciate that the wand 18 could have one or more of these modules/openings extending in other orientations relative to the other modules/openings (e.g., generally transversely instead of generally parallel and/or generally parallel instead of generally transversely).

Moreover, the shell 34 and the waterway 36 have been shown and described as having portions that are separately formed and portions that are unitarily formed. However, one of ordinary skill in the art will appreciate that the shell 34 and the waterway 36 could be completely separately formed, completely unitarily formed, or partially separately formed and partially unitarily formed.

Additionally, the flow module 38′ has been shown and described as including a flow control mechanism 116′ and the flow module 38 has been shown and described as including a flow piston 116. However, one of ordinary skill in the art will appreciate that the flow module 38′, 38 could include other flow control mechanisms, such as ceramic disks. Further, the flow piston 116 has been shown and described as having various structural features. However, one of ordinary skill in the art will appreciate that the flow piston 116 could have other structural features. For example, the flow piston 116 has been shown and described as having a circular large flow opening 136 and a circular small flow opening 138. However, one of ordinary skill in the art will appreciate that the flow piston 116 could have more or less flow openings and/or flow openings with different shapes and sizes. Similarly, the flow module 38 has been shown and described as including various springs, seals, and other structural features. However, one of ordinary skill in the art will appreciate that the flow module 38 could include other spring, seal, and structural arrangements to create the mechanical forces, the hydraulic forces, and/or the friction forces that accomplish the flow features of the flow module 38.

Further, the flow actuator module 42′ has been shown and described as including a flow actuation mechanism 140′ and the flow actuator module 42 has been shown and described as including a flow lever 140. However, one of ordinary skill in the art will appreciate that the flow actuator module 42′, 42 could include other flow actuation mechanisms, such as buttons.

Moreover, the flow lock module 44′ has been shown and described as including a lock mechanism 148′ and the flow lock module 44 has been shown and described as including a lock pin 148. However, one of ordinary skill in the art will appreciate that the flow lock module 44′, 44 could include other lock mechanisms, such as a lock arm. Further, the lock pin 148 has been shown and described as having various structural features. However, one of ordinary skill in the art will appreciate that the lock pin 148 could have other structural features. Similarly, the flow lock module 44 has been shown and described as including various springs and other structural features. However, one of ordinary skill in the art will appreciate that the flow lock module 44 could include other spring and structural arrangements to create the mechanical forces, the hydraulic forces, and/or the friction forces that accomplish the flow lock features of the flow lock module 44.

Additionally, the flow module 42 has been shown and described as having a first flow position that is a minimum flow position delivering a first volume of water that is a minimum volume of water and a second flow position that is a maximum flow position delivering a second volume of water that is a maximum volume of water. However, one of ordinary skill in the art will appreciate that the flow module 42 could have a first flow position that is not a minimum flow position delivering a first volume of water that is not a minimum volume of water and a second flow position that is not a maximum flow position delivering a second volume of water that is not a maximum volume of water.

Further, the flow lock module 44 has been shown and described as having a single lock position in the maximum flow position. However, one of ordinary skill in the art will appreciate that the flow lock module 44 could have the lock position in another flow position and/or the flow lock module 44 could have multiple lock positions.

Moreover, actuation of the flow lever 140 has been shown and described as a pressing action, and actuation of the lock pin 148 has been shown and described as a pressing action. However, one of ordinary skill in the art will appreciate that actuation of the flow lever 140 or any other flow actuation mechanism 140′ and actuation of the lock pin 148 or any other lock mechanism 148′ could be accomplished by other actions, such as pushing, pulling, rotating, twisting, and any other movement of the flow lever 140 or the flow actuation mechanism 140′ and the lock pin 148 or the lock mechanism 148′ that accomplishes the flow actuation features of the flow actuator module 42, 42′ and the flow lock features of the flow lock module 44, 44′, respectively.

One of ordinary skill in the art will now appreciate that the present invention provides a wand with variable flow and a flow lock. Although the present invention has been shown and described with reference to particular embodiments, equivalent alterations and modifications will occur to those skilled in the art upon reading and understanding this specification. The present invention includes all such equivalent alterations and modifications and is limited only by the scope of the following claims in light of their full scope of equivalents.

What is claimed is:

1. A wand, comprising:
a shell, the shell operable to pull away from a body of a faucet;
a waterway, the waterway operable to be substantially disposed in the shell, the waterway including a first flow passage and a second flow passage;
a flow module, the flow module operable to be disposed between the first flow passage and the second flow passage, the flow module including a flow control mechanism, the flow control mechanism operable to move between a first position and a second position, in the first position, a first volume of water flows from the first flow passage through the flow control mechanism to the second flow passage, in the second position, a second volume of water flows from the first flow passage through the flow control mechanism to the second flow passage;
a flow actuator module, the flow actuator module including a flow actuation mechanism, the flow actuation mechanism operable to move between a first position and a second position, as the flow actuation mechanism is moved from the first position to the second position, the flow control mechanism is moved from the first position to the second position, as the flow actuation mechanism is moved from the second position to the first position, the flow control mechanism is moved from the second position to the first position; and
a flow lock module, the flow lock module including a lock mechanism, the lock mechanism operable to move between a first position and a second position, when the lock mechanism is in the first position, the flow control mechanism is operable to move between the first position and the second position, when the lock mechanism is in the second position, the flow control mechanism is not operable to move between the first position and the second position and is locked in the second position;
wherein, when the lock mechanism is in the second position, the lock mechanism is operable to move from the second position to the first position by at least one of actuating the flow actuation mechanism and actuating the lock mechanism; and
wherein, when the lock mechanism is moved from the second position to the first position, the flow control mechanism is operable to move from the second position to the first position.

2. The wand of claim 1, wherein:
the flow control mechanism is biased to the first position; and
the lock mechanism is biased to the first position.

3. The wand of claim 1, wherein:
the first volume of water is a minimum volume of water; and
the second volume of water is a maximum volume of water.

4. The wand of claim 1, wherein:
the flow control mechanism is a flow piston.

5. The wand of claim 1, wherein:
the lock mechanism is a lock pin.

6. The wand of claim 1, wherein:
the flow actuation mechanism is a flow lever.

7. The wand of claim 1, wherein the shell and the waterway are any one of separately formed, unitarily formed, and partially separately formed and partially unitarily formed.

8. A wand, comprising:
a shell, the shell operable to pull away from a body of a faucet;
a waterway, the waterway operable to be substantially disposed in the shell, the waterway including a first flow passage and a second flow passage;
a flow module, the flow module operable to be disposed between the first flow passage and the second flow passage, the flow module including a flow control mechanism, the flow control mechanism operable to move between a first position and a second position, in the first position, a first volume of water flows from the first flow passage through the flow control mechanism to the second flow passage, in the second position, a second volume of water flows from the first flow passage through the flow control mechanism to the second flow passage;
a flow actuator module, the flow actuator module including a flow actuation mechanism, the flow actuation mechanism operable to move between a first position and a second position, as the flow actuation mechanism is moved from the first position to the second position, the flow control mechanism is moved from the first position to the second position, as the flow actuation mechanism is moved from the second position to the first position, the flow control mechanism is moved from the second position to the first position; and
a flow lock module, the flow lock module including a lock mechanism, the lock mechanism operable to move between a first position and a second position, when the lock mechanism is in the first position, the flow control mechanism is operable to move between the first position and the second position, when the lock mechanism is in the second position, the flow control mechanism is not operable to move between the first position and the second position and is locked in the second position;
wherein, when the lock mechanism is in the second position, the lock mechanism is operable to move from the second position to the first position by both of actuating the flow actuation mechanism and actuating the lock mechanism; and
wherein, when the lock mechanism is moved from the second position to the first position, the flow control mechanism is operable to move from the second position to the first position.

9. The wand of claim 8, wherein:
the flow control mechanism is biased to the first position; and
the lock mechanism is biased to the first position.

10. The wand of claim 8, wherein:
the first volume of water is a minimum volume of water; and
the second volume of water is a maximum volume of water.

11. The wand of claim 8, wherein:
the flow control mechanism is a flow piston.

12. The wand of claim 8, wherein:
the lock mechanism is a lock pin.

13. The wand of claim 8, wherein:
the flow actuation mechanism is a flow lever.

14. The wand of claim 8, wherein the shell and the waterway are any one of separately formed, unitarily formed, and partially separately formed and partially unitarily formed.

15. A wand, comprising:
a shell, the shell operable to pull away from a body of a faucet;
a waterway, the waterway operable to be substantially disposed in the shell, the waterway including a first flow passage and a second flow passage;
a flow module, the flow module operable to be disposed between the first flow passage and the second flow passage, the flow module including a flow control mechanism, the flow control mechanism operable to move between a first position and a second position, in the first position, a first volume of water flows from the first flow passage through the flow control mechanism to the second flow passage, in the second position, a second volume of water flows from the first flow passage through the flow control mechanism to the second flow passage, as the flow control mechanism is moved from the first position to the second position, a varying volume of water between the first volume of water and the second volume of water flows from the first flow passage through the flow control mechanism to the second flow passage;
a flow actuator module, the flow actuator module including a flow actuation mechanism, the flow actuation mechanism operable to move between a first position and a second position, as the flow actuation mechanism is moved from the first position to the second position, the flow control mechanism is moved from the first position to the second position, as the flow actuation mechanism is moved from the second position to the first position, the flow control mechanism is moved from the second position to the first position; and
a flow lock module, the flow lock module including a lock mechanism, the lock mechanism operable to move between a first position and a second position, when the lock mechanism is in the first position, the flow control mechanism is operable to move between the first position and the second position, when the lock mechanism is in the second position, the flow control mechanism is not operable to move between the first position and the second position and is locked in the second position;
wherein, when the lock mechanism is in the second position, the lock mechanism is operable to move from the second position to the first position by at least one of actuating the flow actuation mechanism and actuating the lock mechanism; and
wherein, when the lock mechanism is moved from the second position to the first position, the flow control mechanism is operable to move from the second position to the first position.

16. The wand of claim 15, wherein:
the flow control mechanism is biased to the first position; and
the lock mechanism is biased to the first position.

17. The wand of claim 15, wherein:
the first volume of water is a minimum volume of water, and
the second volume of water is a maximum volume of water.

18. The wand of claim 15, wherein:
the flow control mechanism is a flow piston.

19. The wand of claim 15, wherein:
the lock mechanism is a lock pin.

20. The wand of claim 15, wherein:
the flow actuation mechanism is a flow lever.
